(19) United States
(12) Patent Application Publication
(10) Pub. No.: US 2006/0087959 A1
(43) Pub. Date: Apr. 27, 2006

(54) Optical disk

(75) Inventors: Kazuyoshi Adachi, Ibaraki (JP); Osamu Ishizaki, Ibaraki (JP); Akemi Hirotsune, Kokubunji (JP); Junko Ushiyama, Kokubunji (JP)

Correspondence Address: BIRCH STEWART KOLASCH & BIRCH, PO BOX 747, FALLS CHURCH, VA, 22040-0747, US

(73) Assignee: HITACHI MAXELL, LTD., Ibaraki-shi (JP)

(21) Appl. No.: 11/250,486

(22) Filed: Oct. 17, 2005

(30) Foreign Application Priority Data
Oct. 18, 2004 (JP) 2004-303147

(51) Int. Cl. G11B 7/24

(52) U.S. Cl. 369/275.1; 369/272.1

(57) ABSTRACT

An optical disk of a land-and-groove recording system capable of reducing a track pitch while suppressing the drop of an S/N ratio of reproduction signals is provided. The optical disk includes guide groove portions and space portions between the groove portions and is loaded to an optical disk recording/reproduction apparatus having a mechanism for removing or reducing leakage signals from adjacent tracks by using three or more light beam spots and signals are recorded to the groove portions and the space portions between the groove portions, wherein a wavelength λ of reproduction light irradiated from the optical disk recording/reproduction apparatus and a refractive index n of a cover layer on an incidence side of reproduction light or a substrate are from λ/12n to λ/6n.

### BACKGROUND OF THE INVENTION

1. Field of the Invention

This invention relates to an optical disk. More particularly, the invention relates to an optical disk which is loaded to an optical disk recording/reproduction apparatus having a crosstalk reduction mechanism and in which signals are recorded to both guide groove and space between the guide grooves.

2. Description of the Related Art

Optical disks capable of recording information signals according to the prior art include an optical disk of a phase change type that causes a change of optical constants in a recording layer by irradiation of a laser beam, an optical disk of a shape change type that causes a change of a physical shape in the recording layer by irradiation of the laser beam and an magneto-optical disk that uses a material layer having a magneto-optical effect such as a rare earth transition metal amorphous alloy thin film for the recording layer.

Recording of information signals to such recording type optical disks is generally conducted along guide grooves that are formed as spiral or concentric grooves on one main surface of a transparent substrate.

In other words, areas corresponding to the guide grooves (hereinafter called “grooves”) and areas corresponding to hills between the grooves (hereinafter called “lands”) are formed on the transparent substrate. Recording of the information signals in the prior art is conducted by using either one of these groove and land as a recording track and the other as a guard band for isolating adjacent tracks from one another.

A recording capacity in such an optical disk can be increased by improving a recording density in a linear direction and a recording density in a track direction. The improvement of the recording density in the linear direction can be accomplished by decreasing a spot diameter of a recording beam and reducing a pit length. On the other hand, the improvement of the recording density in the track direction can be accomplished by reducing a track pitch.

An optical disk of the type other than those described above, that is, a land-and-groove recording system for recording information signals to both groove and land, has been proposed in the past (refer to JP-A-57-50330, for example). The optical disk of this system is more advantageous for improving the recording density in the track direction than the optical disks of the system that record the information signals to only one of the groove and the land. When the track pitch is reduced to improve the recording density in this system, however, the recording tracks of the groove and the land overlap inside the light beam spot for signal reproduction and leakage of the signals from the adjacent tracks (crosstalk) occurs during signal reproduction with the result of the drop of an S/N ratio of the reproduction signals.

A technology that sets the depth d of the groove to the proximity of λ/6n (where λ: laser wavelength, n: refractive index of transparent substrate) so as to make the crosstalk amount minimal by taking an optical phase into consideration has been proposed as one of the technologies for suppressing the crosstalk in the optical disks of the land-and-groove recording system (refer to JP-A-5-282705, for example). In the optical disks in which the phase depth d of the groove is so set as to satisfy this condition, the crosstalk amount from the adjacent tracks becomes minimal. Even when the laser beam is irradiated to the adjacent lands while the groove is reproduced, for example, the quantity of reflected light from the land can be suppressed to a small value. This also holds true of the case where the relation between the groove and the land is reversed.

Nonetheless, the crosstalk amount cannot be made completely zero even when the depth d of the groove is set near to λ/6n but varies depending on the spot diameter of reproduction light and on the track pitch. When the track pitch is reduced to 0.7 times or below of the spot diameter of reproduction light (a value determined by 0.84×λ/NA; where λ is wavelength of reproduction light and NA is numerical aperture of objective lens) in order to improve the recording density, the problem of the crosstalk during signal reproduction yet remains unsolved as the practical problem.

On the other hand, a so-called “crosstalk cancel technology” has been conventionally proposed as a technology for suppressing the crosstalk in an optical disk recording/reproduction apparatus that uses three optical beams, that is, a main optical beam and two sub-optical beams positioned on both adjacent sides of the main optical beam, and removes signal components of adjacent tracks contained in the reflected light signals of the main optical beam on the basis of the reflected light signal of each sub-optical beam (refer to JP-A-9-171620, for example).

### SUMMARY OF THE INVENTION

Incidentally, a step between the land and the groove in the optical disk is ideally constituted by a vertical plane but it is practically difficult to shape the step into the vertical plane. Generally, the step is a slope having an angle of inclination of about 50 degrees. Since the width of the step having such a slope surface is determined by the depth of the groove, a ratio of the width of the step becomes relatively greater when the track pitch is narrowed while the depth is kept constant and the flat portion of each of the groove and the land becomes narrower as much. The width of the step becomes relatively greater with the increase of the depth of the groove even when the track pitch remains the same and the flat portion of each of the groove and the land similarly becomes narrower. When the track pitch is narrowed in this way to accomplish a higher density, the flat portion of each of the groove and the land becomes narrower, the intensity of the reproduction signal drops owing to the drop of the quantity of reflected light and the S/N (signal-to-noise) ratio of the reproduction signal drops.

When the track pitch is set to 0.6 times or below of the spot diameter of reproduction light in the optical disk of the land-and-groove recording system, too, the crosstalk from the adjacent tracks can be removed or reduced by using the optical disk recording/reproduction apparatus having the crosstalk cancel mechanism described above but the drop of the S/N ratio of the reproduction signals resulting from narrowing of the flat portion of the groove and the land cannot be compensated.

To solve the problems of the prior art described above, the invention contemplates to provide an optical disk of a land-and-groove recording system that can reduce a track pitch while suppressing the drop of an S/N ratio of a reproduction signal.

To accomplish this object, the invention provides an optical disk of the type which has guide grooves and spaces between the grooves and is loaded to light beam spots recording/reproduction apparatus having a mechanism for removing or reducing leakage signals from adjacent tracks by the use of three or more optical spots and in which signals are recorded to the grooves and to the spaces between the grooves, wherein a depth d of the guide groove is from λ/12n to λ/6n when a wavelength of reproduction light irradiated from the optical disk recording/reproduction apparatus is λ and a refractive index of a cover layer on an incidence side of reproduction light or a refractive index of a substrate is n.

When the depth of the guide groove is limited to the range described above, the depth is shallower than λ/6n that is the groove depth at which the crosstalk becomes minimal and the proportion of the step to the flat portion of each of the groove and the land can be decreased. In consequence, the drop of the S/N ratio of the reproduction signals when the track pitch is narrowed can be suppressed. Since the crosstalk that becomes greater when the groove depth is smaller can be suppressed by the crosstalk cancel mechanism to the level that renders no practical problem, the recording density can be improved by the reduction of the track pitch of the optical disk. In other words, to exploit the crosstalk components reduction effect brought forth by the crosstalk cancel mechanism when the track pitch is narrowed to a predetermined value or below, the margin obtained by this effect can be utilized as means for increasing the signal component to enlarge the flat portions of the groove and the land. As a result, the error rate reaches optimum at a portion shallower than the optimal groove depth of the prior art.

Incidentally, when the groove depth is set to λ/6n or more at which the crosstalk becomes minimal, the flat portions of the groove and the land cannot be secured sufficiently. Therefore, even when the crosstalk cancel mechanism operates effectively to remove the crosstalk components, the signal components per se cannot be enlarged.

Particularly when the track pitch is narrowed or more concretely, when the spot diameter φ of the main optical beam is expressed as φ=0.84×λ/NA (Numerical Aperture) and the track pitch is Tp, the effect appears remarkably when Tp/φ≦0.70 and remains effective down to Tp/φ≧=0.50.

Other objects, features and advantages of the invention will become apparent from the following description of the embodiments of the invention taken in conjunction with the accompanying drawings.

### BRIEF DESCRIPTION OF THE DRAWINGS

FIG. 1 is a sectional view of an optical disk according to an embodiment of the invention;

FIG. 2 is a table showing measurement results of crosstalk amounts and error rates when a track pitch is variously changed while a groove depth is kept fixed at λ/6n;

FIG. 3 is a table showing measurement results of the crosstalk amounts and the error rates when the groove depth d is variously changed while the track pitch is kept fixed at 0.20 μm; and

FIG. 4 is a table showing measurement results of the crosstalk amounts and the error rates when the groove depth d is variously changed while the track pitch is kept fixed at 0.28 μm.

### DESCRIPTION OF THE EMBODIMENTS

Optical disks according to embodiments of the invention will be hereinafter explained with reference to the accompanying drawings.

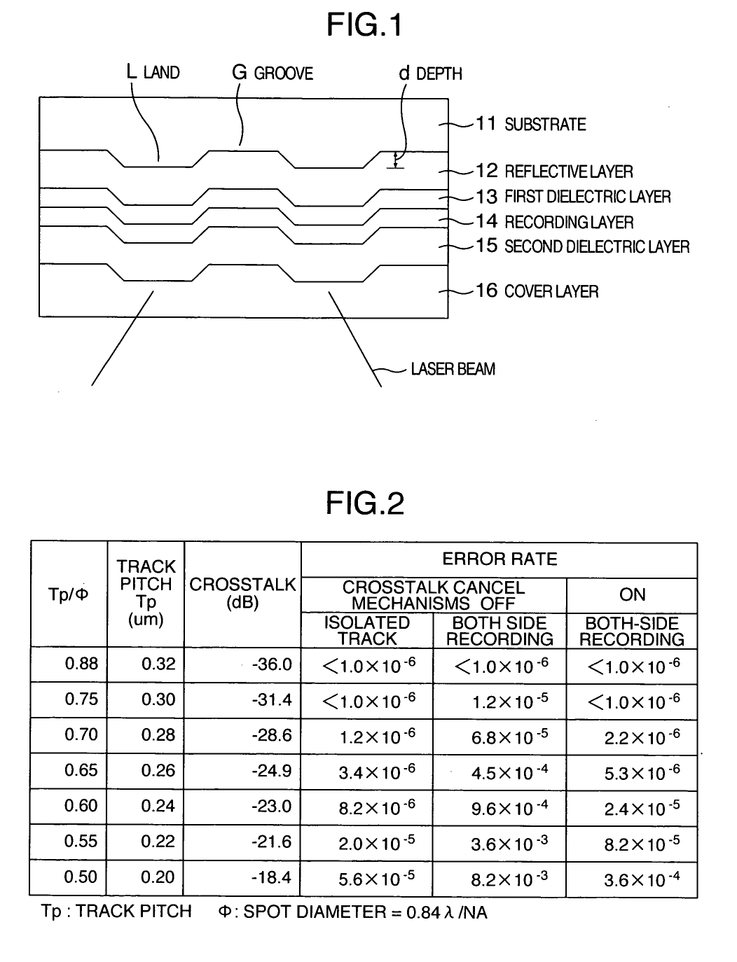

FIG. 1 is a sectional view of an optical disk according to an embodiment of the invention. The drawing shows a film surface incidence type optical disk with a recording layer that is made of a phase change material. As is obvious from the drawing, the optical disk of this embodiment includes a substrate 11 on which guide grooves G and lands L between the grooves are formed, a reflective layer 12, a first dielectric layer 13, a recording layer 14 formed of a phase change material and a second dielectric layer 15 that are serially formed by sputtering on the substrate 11, and a transparent cover layer 16 of a UV curable resin and formed by spin coating on the second dielectric layer 15. An injection molding of polycarbonate on which the grooves G and the lands L are formed into substantially the same width is used for the substrate 11. An AgAu alloy is used for the reflective layer 12 and its film thickness is about 50 nm. ZnS—SiO₂ is used for the first dielectric layer 13 and the second dielectric layer 15 and the film thickness is about 20 nm and about 55 nm, respectively. A phase change recording material having a composition Ge₅Sb₂Te₈ composition is used for the recording layer 14 and its film thickness is about 20 nm. The cover layer 16 has a thickness of about 0.1 mm.

Incidentally, each material and each film thickness given above merely represent an example and the gist of the invention is not limited thereto. These values can be selected appropriately depending on a recording/reproduction system (reflectivity modulation system, opto-magnetic recording system) of the magnetic disk and its capacity.

It is possible to use a resin material such as an acrylic resin, a methacrylic resin, a polycarbonate resin, a polyolefin resin (amorphous polyolefin, in particular), a polyester resin, a polystyrene resin, an epoxy resin, etc, glass and substrates fabricated by disposing a resin layer of a radiation curable resin such as a photo-curable resin on glass, as the material of the substrate 11 besides the polycarbonate. The injection molding of the polycarbonate is preferred from the aspects of high productivity, low cost of production and high moisture resistance.

The reflective layer 12 is formed of a metal layer or an alloy layer having a high optical reflectivity such as an AgAu alloy. More concretely, a metal layer of a metal selected from the group consisting of Au, Al, Ag, Cu, Ti, Cr, Ni, Pt, Ta, Cr and Pd or an alloy containing at least one kind of the metal selected from this metal group as its main component can be used. Incidentally, the metal layer or alloy layer constituting the reflective layer 12 can contain metals and semi-metals such as Mg, Se, Hf, V, Nb, Ru, W, Mn, Re, Fe, Co, Rh, Ir, Cu, Zn, Cd, Ga, In, Si, Ge, Te, Pb, Po, Sn and Bi as addition elements.

The first dielectric layer 13 and the second dielectric layer 15 are arranged on both sides of the recording layer 14 while interposing the recording layer 14 between them. Materials for forming the first and second dielectric layers 13 and 15 include oxides such as SiO₂, Al₂O₃, Cr₂O₃, SnO₂ and Ta₂O₅ and nitrides such as SiN, GeN, TaN and AlN besides a mixture of ZnS and SiO₂.

The recording layer 14 can be formed of known and arbitrary heat mode recording materials or photon mode recording materials besides the phase change materials. Among them, the recording layer 14 formed of the phase change material is excellent in that deformation occurs difficultly. The recording layer 14 formed of the phase change material records data through its phase change from the crystalline phase to the amorphous phase and vice versa. Concrete examples of the phase change type recording materials include an Sb—Te system, a Ge—Te system, a Ge—Sb—Te system, an In—Sb—Te system, an Ag—In—Sb—Te system, a MA-Ge—Sb—Te system (where MA is at least one element selected from the group consisting of Au, Cu, Pd, Ta, W, Ir, Sc, Y, Ti, Zr, V, Nb, Cr, Mo, Mn, Fe, Ru, Co, Rh, Ni, Ag, Tl, S, Se and Pt), an Sn—Sb—Te system, an In—Se—Tl system, an In—Se—Tl-MB system (where MB is at least one element selected from the group consisting of Au, Cu, Pd, Ta, W, Ir, Sc, Y, Ti, Zr, V, Nb, Cr, Mo, Mn, Fe, Ru, Co, Rh, Ni, Ag, Tl, S, Se and Pt) and an Sn—Sb—Se system.

A UV curable resin prepared by subjecting a pre-polymer component and a monomer component to a curing reaction by using a photo polymerization initiator such as benzophenone or benzoin ether is generally used as the material of the cover layer 16. Examples of the pre-polymer component are polyester acrylate, polyurethane acrylate, epoxy acrylate and polyether acrylate. Examples of the monomer component are dicyclopentanyl diacrylate, ethylene oxide (EO) modified bisphenol-A acrylate, trimethylpropane triacrylate, EO modified trimethylolpropane triacrylate and dipentaerythritol hexaacrylate. It is also possible to bond a thin and transparent sheet such as polycarbonate through a pressure sensitive curable resin to form the cover layer.

Next, the explanation will be given on the change of a crosstalk amount from adjacent tracks and the change of an error rate of a reproduction signal when recording and reproduction of signals is conducted by variously changing a track pitch and a groove depth for the optical disk having the disk structure shown in FIG. 1. Incidentally, recording and reproduction of the signals is conducted at a wavelength of a recording/reproduction light of 405 nm and NA of an objective lens of 0.85 by using an optical disk recording/reproduction apparatus having a crosstalk cancel mechanism for removing signal components of adjacent tracks contained in reflected light signals of a main optical beam on the basis of reflected light signals of each sub-optical beam by irradiating three optical beams, that is, the main optical beam and two sub-optical beams positioned on both adjacent sides of the main optical beam.

Recording of the signals is conducted by using the groove track as the center track. To measure the error rate, the recording signal modulated by a PR (1,7) system is recorded at the shortest mark length of 140 nm and a linear velocity of 4.55 m/s. A PRML system is used for the reproduction system. To measure the crosstalk amount, on the other hand, a repetition pattern of 560 nm mark/space is recorded. The crosstalk amount is determined as crosstalk amount=(C Side)−(C_center) when the carrier level of the recording track is C_center and the mean value of the carrier levels leaking into both side tracks adjacent to the recording track is C_side.

FIG. 2 shows the measurement result of the crosstalk amounts and the error rates when the groove depth is fixed at λ/6n and the track pitch is variously changed. Incidentally, the error rates shown in FIG. 2 are represented by the values having the lowest error rates when the measurement is made by changing recording power. It can be appreciated from FIG. 2 that the crosstalk amount increases with the decrease of the track pitch width. The error rate when the crosstalk cancel mechanism is not used increases with the decrease of the track pitch width, too. In other words, even when the groove depth d is set to the phase depth at which the crosstalk becomes minimal, the crosstalk amount increases when the track pitch becomes narrow. Because the error rate at the practical level is 4×10⁻⁴, the track pitch of up to about 0.28 μm is found as the limit of the practical level when recording is made to both side tracks without using the crosstalk cancel mechanism. The track pitch at this time is expressed as Tp/φ=0.70 when the spot diameter φ of the main optical beam is φ=0.84×λ/NA and the track pitch is Tp.

When the crosstalk cancel mechanism is used, in contrast, the error rate is limited to a lower rate than when this mechanism is not used, and the error rate can be suppressed to that of an isolated track when recording is made to only the groove track. In other words, the crosstalk can be eliminated to a level approximate to the level at which the influences of recording of the adjacent tracks do not exist. When the track pitch is narrowed to 0.20 μm, however, the error rate is almost approximate to the error rate of the practical level. The track pitch in this case is Tp/φ=0.50 under the same condition as described above.

On the other hand, the error rate of the isolated track is sufficiently low but increases with narrowing of the track pitch. The error rate of the isolated track exists under the condition in which recording is not made to the adjacent tracks or grooves, that is, when the influences of the crosstalk do not exist. Therefore, the increase of the error rate of the isolated track results from the drop of S/N of reproduction as the flat portion of the groove becomes narrow with narrowing of the track pitch.

The error rate when the crosstalk cancel mechanism is used cannot be improved beyond the error rate of the isolated track as the model free from the influences of the crosstalk. Therefore, to further reduce the error rate while effectively exploiting the effects of the crosstalk cancel mechanism, it can be understood that the error rate of the isolated track must be reduced. In other words, it is necessary to secure as much as possible the flat portions of the grooves that decrease with narrowing of the track pitch and to suppress the drop of reproduction S/N.

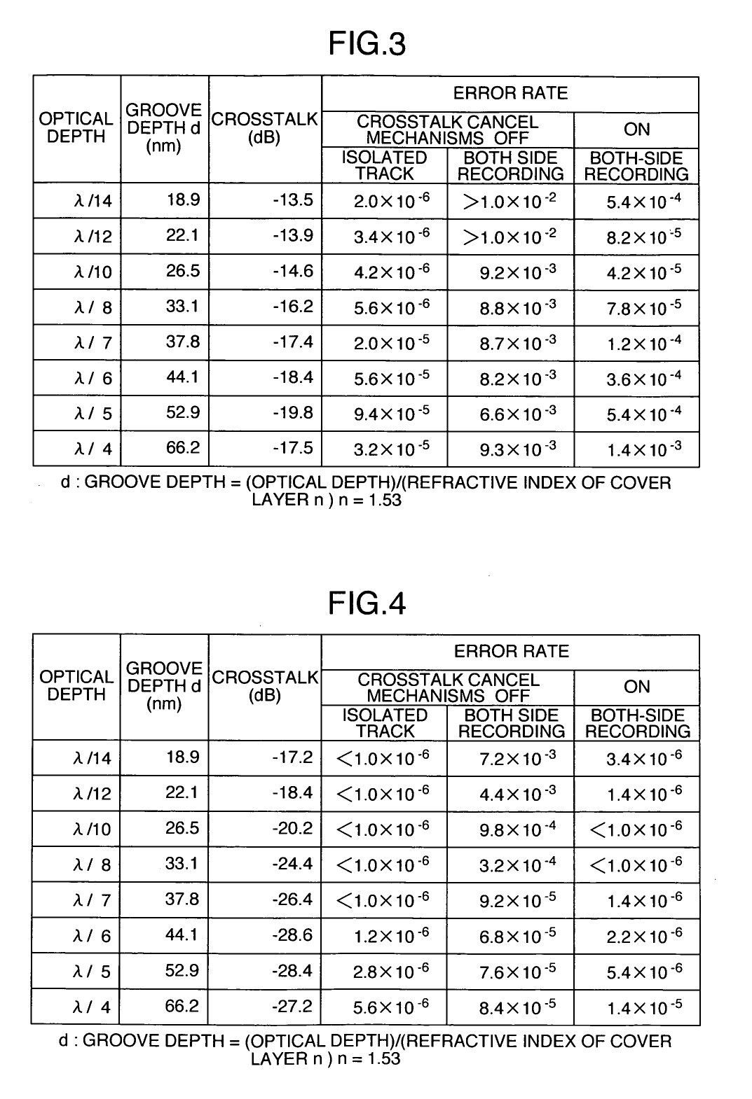

FIG. 3 shows the measurement result of the crosstalk amount and the error rates when the track pitch is kept at 0.20 μm and the groove depth d is variously changed. As can be clearly understood from the table, the optical phase condition deviates with the decrease of the groove depth and the crosstalk amount increases.

When recording is made to both side tracks and when the crosstalk cancel mechanism is not used, the error rate of 4×10⁻⁴ as the practical level cannot be cleared irrespective of the groove depth because the crosstalk amount is great. When the crosstalk cancel mechanism is used, in contrast, the error rate drastically drops though the crosstalk amount increases. Incidentally, the drop of the error rate when the crosstalk cancel mechanism is used corresponds to the drop of the error rate in isolated track recording when the groove depth d is decreased.

The drop of the error rate in isolated track recording when the groove depth d is decreased results from the following reason. Even when the track pitch is decreased to 0.2 μm, the decrease of the groove depth can reduce the width of the slope portion occurring at the step between the groove and the land. In consequence, the flat portion of the groove and the land can be more easily secured and the drop of reproduction S/N owing to the narrow track pitch can be suppressed. In other words, the effects of the crosstalk cancel mechanism can be effectively utilized by reducing the groove depth and the margin brought forth by these effects is allowed to contribute to the increase of the reproduction signal.

Incidentally, the error rate when the crosstalk cancel mechanism is used in FIG. 3 reaches the minimum at the groove depth of λ/10 and when the groove depth is further decreased, the error rate starts increasing. This is because heat at the time of recording is likely to diffuse to the adjacent tracks when the groove depth is too small and signal deterioration due to cross-write starts occurring.

When the crosstalk cancel mechanism is used, therefore, it can be understood that the groove depth d may be set to the range of λ/12n to λ/6n where λ is the wavelength of reproduction light irradiated from the optical disk recording/reproduction apparatus and n is the refractive index of the cover layer on the incidence side of reproduction light when the fact that the error rate of the practical level is 4×10⁻⁴ is taken into consideration.

FIG. 4 shows the measurement result of the crosstalk amounts and the error rates when the track pitch is set to 0.28 μm that is broader than the track pitch in FIG. 3 and the groove depth d is variously changed. As can be seen clearly from the table, the crosstalk amount increases with the decrease of the groove depth d when the track pitch is set to 0.28 μm. When the crosstalk cancel mechanism is not used, the error rate drops on the contrary. This represents the fact that when the crosstalk cancel mechanism is used, the error rate margin can be increased by reducing the groove depth irrespective of the width of the track pitch or in other words, the margin brought forth by the effects of the crosstalk cancel mechanism is allowed to contribute to the increase of the reproduction signal by effectively utilizing the effects of the crosstalk cancel mechanism.

Incidentally, the measurement example given above represents the result when the groove track is used as the center but the same result can be obtained when the land track is used as the center.

The embodiment given above has been explained about the film surface incidence type optical disk in which recording/reproduction light (laser beam) is allowed to be incident from the side of the cover layer 16 but the same effect can be obtained in a substrate surface incidence type optical disk in which the second dielectric layer 15, the recording layer 14 formed of the phase change material, the first dielectric layer 13 and the reflective layer 12 are serially stacked in order named on the substrate 11 and recording/reproduction light is allowed to be incident from the side of the substrate 11.

The optical disk according to the invention is of the type which has guide grooves and spaces between the grooves and is loaded to light beam spots recording/reproduction apparatus having a mechanism for removing or reducing leakage signals from adjacent tracks by using three or more optical spots and in which signals are recorded to the grooves and to the spaces between the grooves, wherein the depth d of the guide groove is from λ/12n to λ/6n where λ is the wavelength of reproduction light irradiated from the optical disk recording/reproduction apparatus and n is the refractive index of the cover layer on the incidence side of reproduction light or the refractive index of the substrate. Therefore, the proportion of the flat portion of the step to the groove or the land can be decreased and the drop of the S/N ratio of the reproduction signal when the track pitch is narrowed can be suppressed. In consequence, the improvement of the recording density owing to narrowing of the track of the optical disk can be achieved in combination with the crosstalk suppression effect by the crosstalk cancel mechanism.

It should be further understood by those skilled in the art that although the foregoing description has been made on embodiments of the invention, the invention is not limited thereto and various changes and modifications may be made without departing from the spirit of the invention and the scope of the appended claims.

1. An optical disk of the type which has guide grooves and spaces between said grooves and is loaded to an optical disk recording/reproduction apparatus having a mechanism for removing or reducing leakage signals from adjacent tracks by using three or more light beam spots and in which signals are recorded to said grooves and to said spaces between said grooves, wherein a depth d of said guide groove is from λ/12n to λ/6n where λ is a wavelength of reproduction light irradiated from said optical disk recording/reproduction apparatus and n is a refractive index of a cover layer on an incidence side of reproduction light or a refractive index of a substrate.

2. An optical disk as defined in claim 1, wherein a spot diameter φ of a main light beam expressed by φ=0.84×λ/NA (numerical aperture) and a track pitch Tp satisfy the relation Tp/φ≦0.70.

3. An optical disk as defined in claim 2, wherein TP/φ≧=0.50.
